(19) United States
(12) Patent Application Publication
(10) Pub. No.: US 2012/0109470 A1
(43) Pub. Date: May 3, 2012

(54) CONTROL DEVICE FOR THE BRAKE SYSTEM OF A VEHICLE

(76) Inventors: Joachim Amtsfeld, Hemmingen (DE); Christian Cornelius, Springe (DE); Johann Lucas, Sehnde (DE); Jens Ohlendorf, Hannover (DE); Hartmut Rosendahl, Hannover (DE); Wolfgang Strache, Hemmingen (DE); Jörg Wolters, Langenhagen (DE)

(21) Appl. No.: 13/382,093

(22) PCT Filed: May 11, 2010
(86) PCT No.: PCT/EP2010/002915

§ 371 Date: Jan. 3, 2012

(30) Foreign Application Priority Data
Jul. 16, 2009 (DE) 10 2009 033 366.5

(51) Int. Cl. B60G 17/0195; H01Q 1/32; B60C 23/00; G06F 19/00; B60T 13/66

(52) U.S. Cl. 701/48

(57) ABSTRACT

The invention relates to a control device for a brake system of a vehicle (10; 92; 132; 238), said vehicle (10; 92; 132; 238) having a supporting structure (222; 240) and a cabin (224; 242) that is supported by the supporting structure (222; 240) and has at least one driver's seat (226). The control device is located outside the cabin (224; 242) on the supporting structure (222; 240) and the control device has additional functionality for controlling an electronic air spring system.

The invention generally relates to embodiments of a control device for a brake system of a vehicle.

In known brake systems, the control device is arranged in a central module in the vicinity of the brake pedal device in the interior of the vehicle in a cabin in which at least a driver's seat is also provided.

Conventionally, from the cabin, numerous electrical lines lead from the central module to various components of the brake system, in particular to a rear axle module, and if appropriate, to a front axle module, wherein the modules have valve devices for modulating pneumatic pressures for pneumatically activating brake cylinders. These modules are attached to a supporting structure of a vehicle. In trucks, this supporting structure is usually formed by a conductor frame. In contrast, buses often have a self-supporting bodywork as a supporting structure. Owing to the large number of electrical lines from and to the central module, thick cable lines lead from the cabin to the supporting structure. Laying such cable lines is complex and costly, in particularly since relative movements occur on a regular basis between the cabin and supporting structure, whether owing to spring movements of the cabin with respect to the supporting structure or owing to the ability of the cabin to tilt with respect to the supporting structure. The latter ability is usually provided in utility vehicles, in particular trucks, in order to permit access to the engine compartment, which is arranged under the driver's cabin. Laying thick cable lines in a flexible way without adversely affecting their reliability is, however, technically demanding and therefore expensive.

It is therefore an object of the invention to solve the foregoing problems and improve such known brake systems. In particular, the laying of lines is simplified, the laying and reliability of cable lines is improved and the costs for development and susceptibility to faults during operation and therefore also costs during operation are reduced.

A solution to problems of conventional systems is attainable with a control device as claimed in claim 1. The control device is embodied such that it can be arranged outside the cabin on the supporting structure of the vehicle. This significantly reduces the number of electrical lines that lead from the cabin to the devices on the supporting structure. As a result, cable lines between the cabin and the supporting structure can be made significantly thinner and therefore more flexible, which improves the mobility of the cable lines.

In addition, the reduction in the number of electrical lines leading from the cabin to the supporting structure (and vice-versa) simplifies the sealing of the cabin in the region of a corresponding cable feedthrough of the cable lines into and out of the cabin. Sealing problems as a result of thick cable lines can therefore be eliminated or significantly improved.

In the cabin itself, the number of electrical lines is also reduced. This reduces material costs, maintenance costs and repair costs. In addition, relatively short line paths reduce the susceptibility of the brake system to faults, increase failure safety and as a result also increase the reliability of the brake system. In particular in the case of trucks with a tiltable front steering driver's cab as a cabin, the arrangement of the control device in the supporting structure causes the number of electrical lines or data lines that have to be bent by a tilting movement of the cabin relative to the supporting structure to be reduced compared to the prior art. Furthermore, there is a saving in space in the cabin, in particular in the region of the front shelf, the dashboard or glove box or the brake pedal device where the control apparatus according to the prior art is usually arranged.

The invention is based on a recognition that the arrangement of the control device on the supporting structure is advantageous, despite the greater degree of expenditure necessary to protect the control device against moisture and particles of dirt (for example increased requirements made of the housing, cable seals), owing to the large number of electrical lines which now no longer have to be led into the cabin, and the inventive embodiment improve over known brake systems.

Furthermore, the control device has an additional functionality for controlling an electronic air spring system. This is to be understood to mean that the control device can control the components of an electronic air spring system such as, for example, a solenoid valve for filling or emptying an air spring bellows. That is, the control electronics of the air spring system are integrated into the control device of the brake system. The electronics have a common housing. Costs are lowered through the integration since a housing is eliminated and the expenditure on cabling is reduced. In particular, cables for supplying power and for the connection to the CAN bus are eliminated. Furthermore, embodiments of the present invention provide savings in installation space since a common control device for the brake system and air spring system takes up less installation space than two separate control devices. This, and also the reduced expenditure on cabling, further reduces the expenditure on assembly of the vehicle.

Advantageous embodiments of the invention are described below.

The control device is located in a housing that protects against the infiltration of water and particles of dirt. In one specific embodiment, the housing is embodied in two parts with an inner housing and an outer housing. In the region of lids or openings, the housings are sealed with seals. Cable connections lead through openings in the inner housing to plug sockets that are let into the outer housing or are arranged on the outer housing. Connections from and to the control device can be produced by plugging plugs into these plug sockets.

The control device preferably has at least one functionality in addition to the functionality of the control device, in particular, the service brake functionality, the additional functionality having the purpose of controlling, in particular a parking brake modulator for making available a parking brake function, an anti-lock brake system for making available an anti-lock brake function, a vehicle movement dynamics control module for controlling the vehicle movement dynamics or the dynamic driving stability and/or an electronically controlled air processing system. The control device is preferably integrated into a rear axle module or a rear axle modulator that is, if appropriate, a parking brake modulator for modulating a pneumatic pressure for a parking brake function of brakes of the vehicle. Furthermore, it is also possible to integrate the control device into a front axle modulator, the vehicle movement dynamics control module or ESC (Electronic Stability Control) module or an electronic air processing module or EAPU (Electronic Air Processing Unit) module. The integration into existing modules reduces costs, in particular, since as a result, the number of electronic control apparatuses, of electrical lines and the number of sealed housings that protect against dirt and moisture is reduced.

According to one advantageous embodiment, at least one sensor for sensing a driving state is integrated in the control device. A driving state is understood to be here, in particular, positive and negative accelerations, quite particularly also lateral accelerations, of the vehicle. The sensor can, for example, be an acceleration sensor, yaw rate sensor and/or inclination sensor and serves to sense a driving state that requires an automatic braking intervention, for example by a vehicle movement dynamics controller. The integration into the control device reduces costs.

According to another advantageous embodiment, the control device has additional functionalities for driver assistance systems, wherein the driver assistance system can have the functions of a lane departure warning system (LDW), an adaptive cruise controller (ACC), a blind spot monitoring system (BSD), and/or an autonomous emergency braking system (AEBS).

According to a further advantageous embodiment, the control device has an additional functionality for controlling a tire pressure monitoring system.

ABS lines that lead from the control device to wheel speed sensors are advantageously used as antennas for receiving signals from tire pressure monitoring modules that detect the tire pressure and are mounted on or in wheels or tire valves of the vehicle. As a result, separate antennas are eliminated since the ABS lines are used as antennas.

The ABS lines can also be used as electrical feed lines to antennas mounted in wheel housings of the vehicle and have the purpose of receiving signals of the tire pressure monitoring modules. In this embodiment, the feed fines to the antennas are eliminated.

A further advantageous embodiment of the invention provides that the tire pressure monitoring modules are assigned to wheel housings or wheels of the vehicle on the basis of the signals of the tire pressure monitoring modules that are transmitted via the ABS lines. This embodiment makes use of the effect according to which the strongest signal can be expected on the ABS line that leads to the associated wheel housing. The assignment is therefore carried out on the basis of the strength of the signal.

Further advantageous embodiments can be found in the dependent claims and in the exemplary embodiments, which are explained in more detail with reference to the drawings, in which:

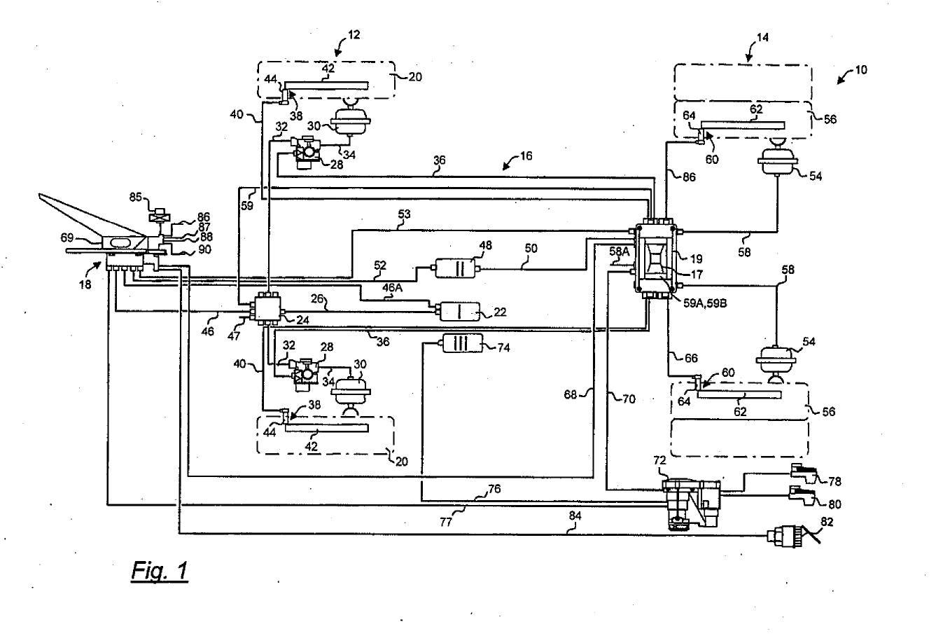

FIG. 1 is a schematic illustration of the brake system according to a first exemplary embodiment;

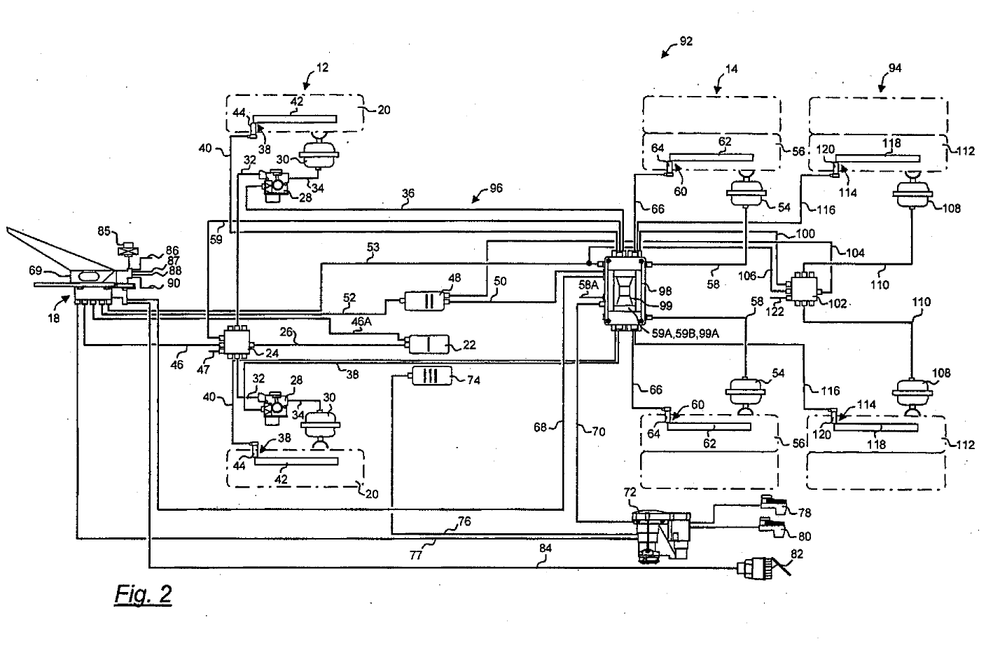

FIG. 2 is a schematic illustration of the brake system according to a second exemplary embodiment;

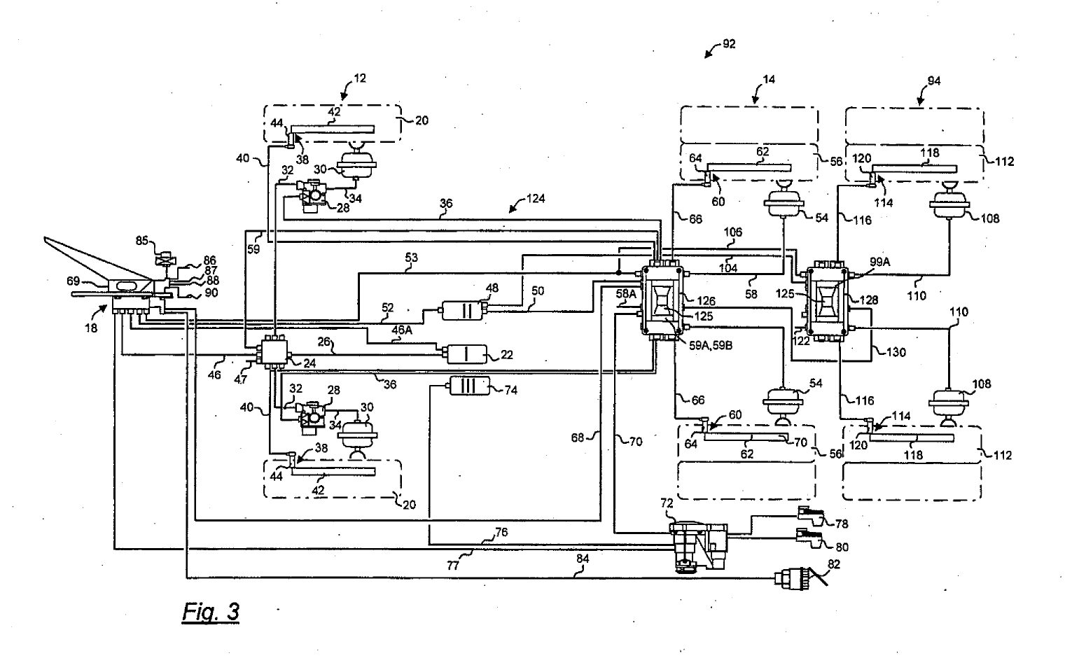

FIG. 3 is a schematic illustration of the brake system according to a third exemplary embodiment;

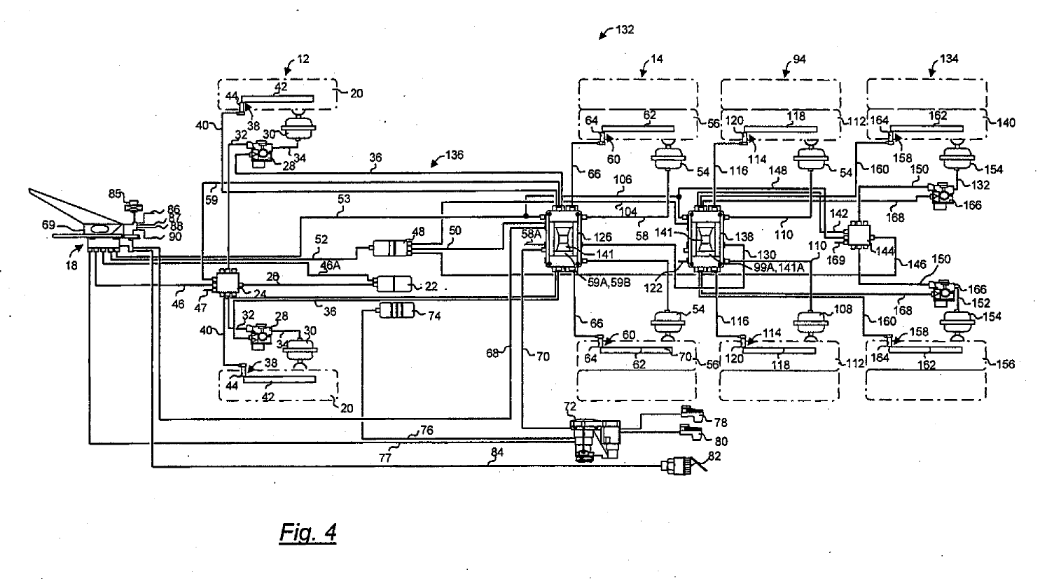

FIG. 4 is a schematic illustration of the brake system according to a fourth exemplary embodiment;

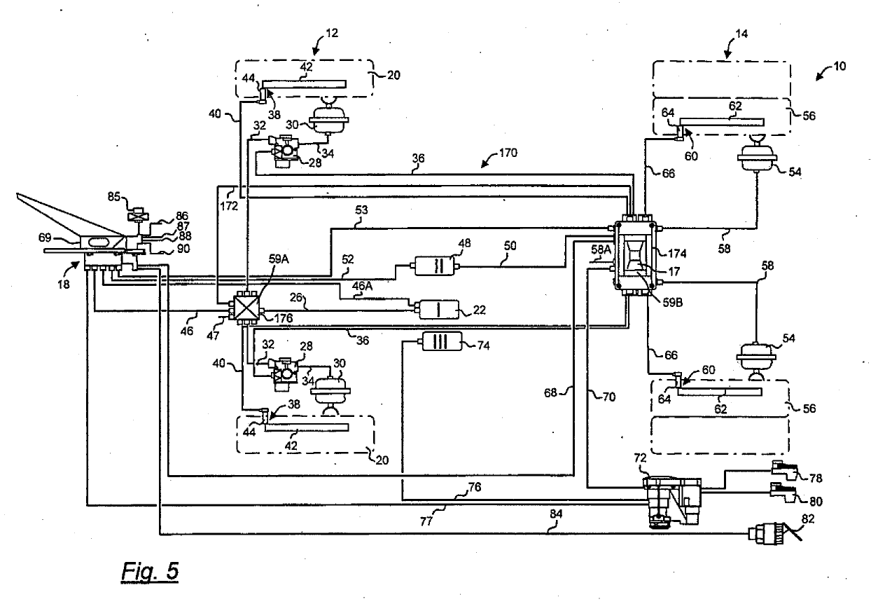

FIG. 5 is a schematic illustration of the brake system according to a fifth exemplary embodiment;

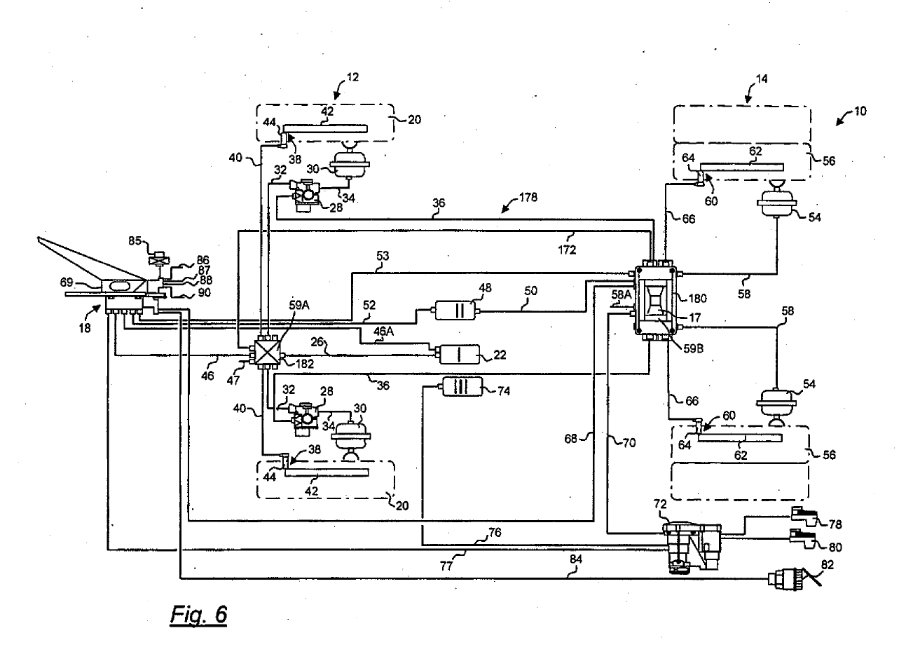

FIG. 6 is a schematic illustration of the brake system according to a sixth exemplary embodiment;

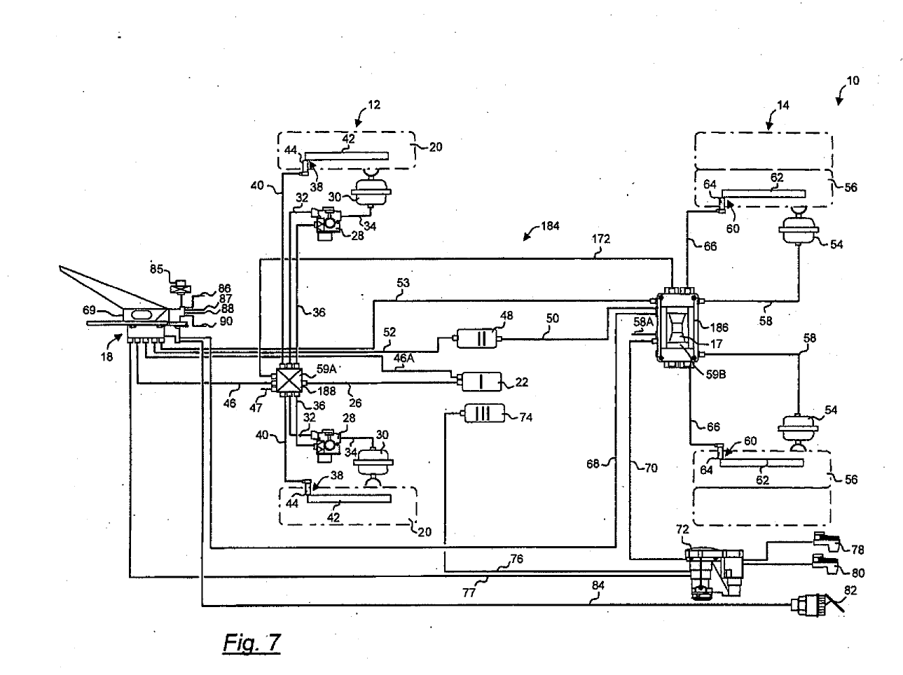

FIG. 7 is a schematic illustration of the brake system according to a seventh exemplary embodiment;

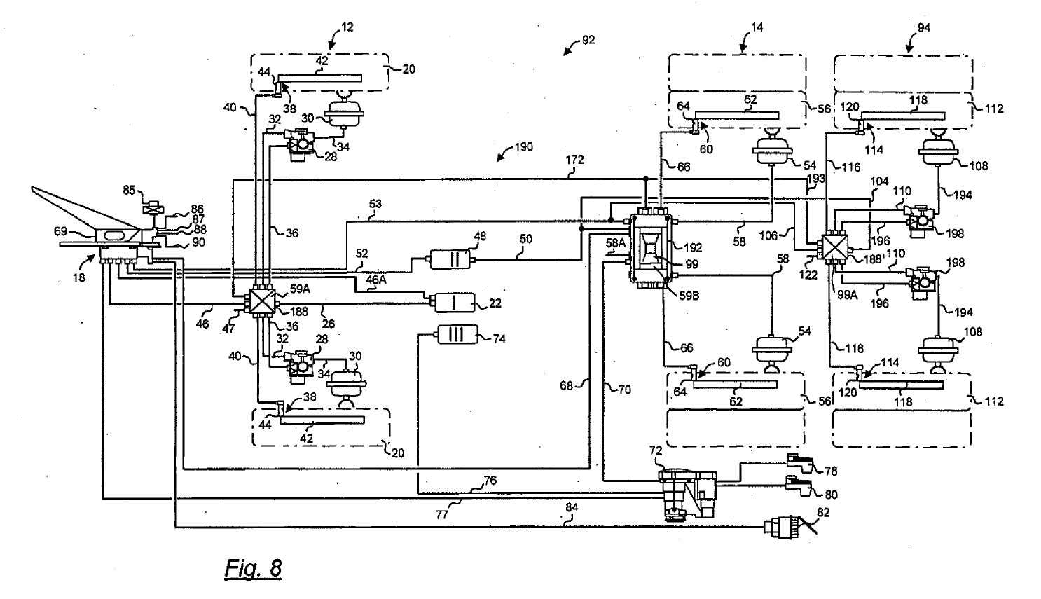

FIG. 8 is a schematic illustration of the brake system according to an eighth exemplary embodiment;

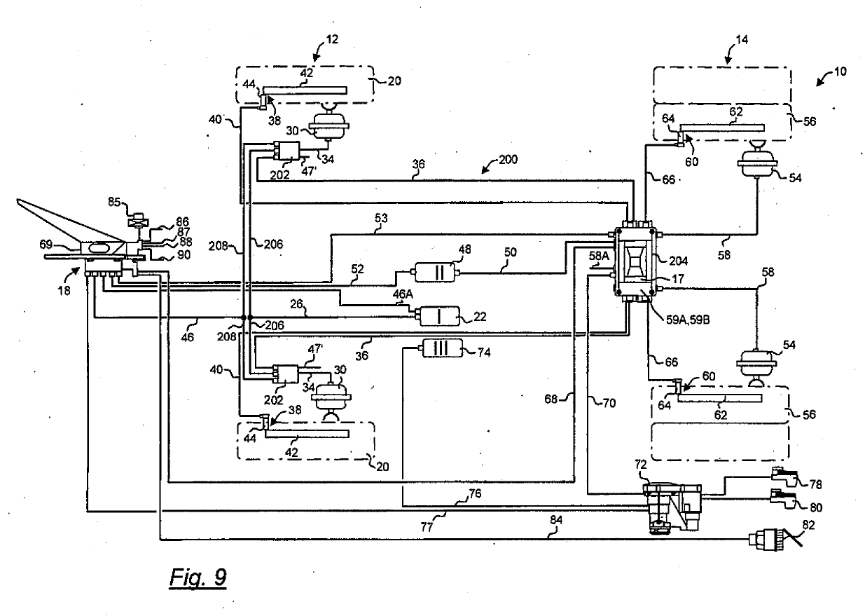

FIG. 9 is a schematic illustration of the brake system according to a ninth exemplary embodiment;

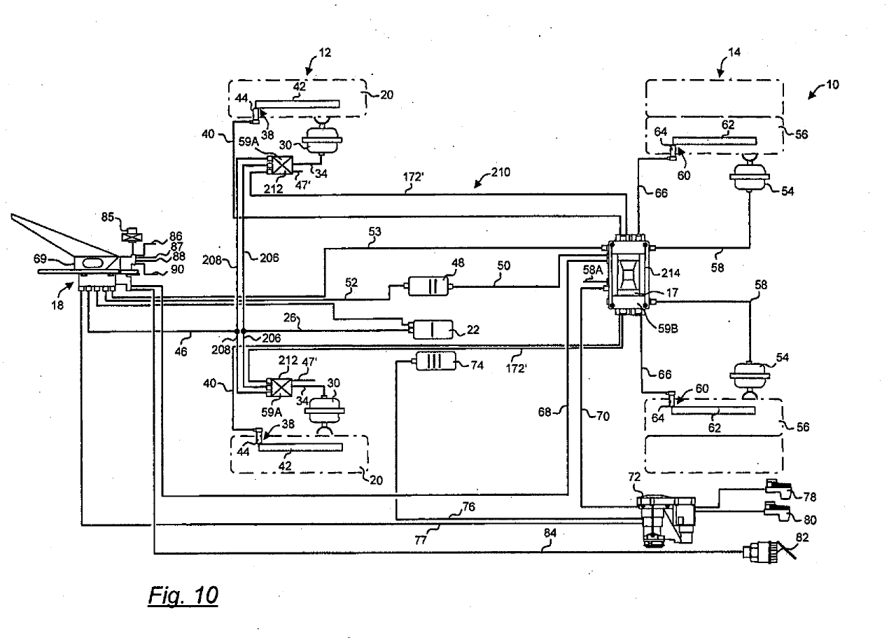

FIG. 10 is a schematic illustration of the brake system according to a tenth exemplary embodiment;

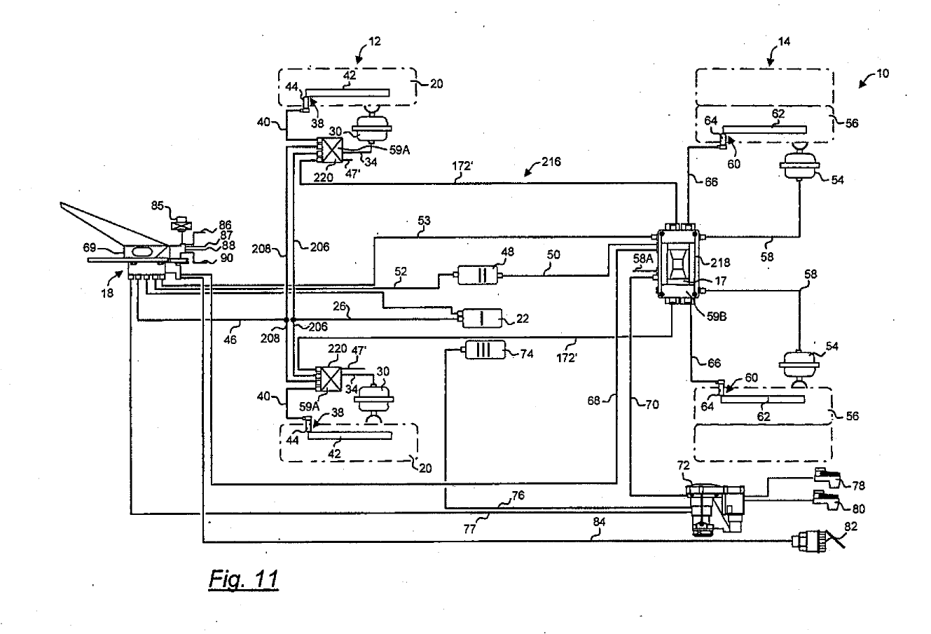

FIG. 11 is a schematic illustration of the brake system according to an eleventh exemplary embodiment of the invention;

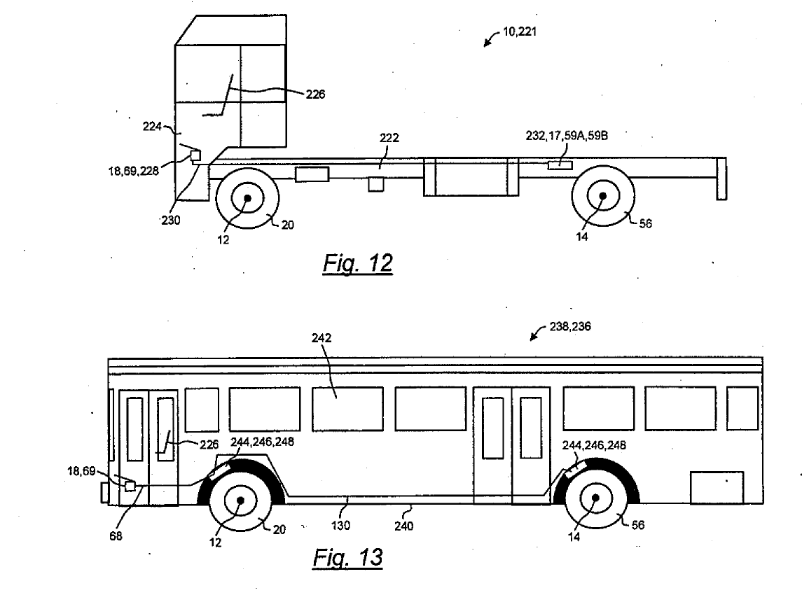

FIG. 12 shows an arrangement of the brake system according to an embodiment of the invention on a vehicle embodied as a truck, in a simplified illustration, and

FIG. 13 shows an arrangement of the brake system according to an embodiment of the invention on a vehicle embodied as a bus, in a simplified illustration.

FIG. 1 is a schematic view of a two-axle vehicle 10 with a front axle 12 and a rear axle 14 as well as a brake system 16. The brake system 16 has a control device by means of which a braking force can be calculated electronically, and a braking force signal can be generated as a function of the calculated braking force. Furthermore, the brake system 16 has three brake circuits of a service brake that can be activated by means of a brake pedal device 18. However, the invention is not restricted to two-axle vehicles and can, in particular, also be used in vehicles with more than two axles, in particular multiple rear axles and/or multiple front axles. A vehicle is also understood to be here, inter alia, a towing vehicle or else a vehicle without a towing function, for example a bus.

A vehicle has a supporting structure and a cabin with a driver's seat. In addition to the driver's seat, the cabin can also have further seats, for example a front passenger's seat, or in the case of a bus a plurality of seats for passengers. In the case of a truck, the supporting structure can be formed from a conductor frame. Buses preferably have a self-supporting bodywork as a supporting structure, but they can also have a frame for holding the cabin.

The brake pedal device 18 is arranged in the cabin in the vicinity of the driver's seat, with the result that it can be foot-operated by a driver. According to an embodiment of the invention, the control device is arranged outside the cabin on the supporting structure, particularly the conductor frame. The control device is therefore not located in the interior of the vehicle 10, which is provided for the driver and, if appropriate, passengers. The control device can be attached, for example screwed, to the supporting structure or can be directly or indirectly arranged on the supporting structure outside the cabin in some other way. Furthermore, the control device has an additional functionality for controlling an electronic air spring system.

Furthermore, FIG. 1 shows a control apparatus 17 that has a first module 19, wherein the first module 19 is a rear axle module. The control device according to an embodiment of the invention is integrated into the control apparatus 17 or into the module 19.

The exemplary embodiment according to FIG. 1 shows a compressed-air-operated brake system 16 with three service brake circuits. A first service brake circuit serves to brake wheels 20 of a front axle 12. The first service brake circuit has a compressed air reservoir vessel 22 that is connected to a second module 24 via a compressed air line 26. The second module 24 is a front axle module in this exemplary embodiment. In addition, the first service brake circuit respectively comprises a valve unit 28 for each of the wheels 20, via which valve unit 28 decompressed air can be fed to and discharged from brake cylinders 30 of brakes on the wheels 20. The valve units 28 are therefore connected to the front axle module 24 via compressed air lines 32 and to the brake cylinders 30 via compressed air lines 34. The front axle module 24 has one or more solenoid valves by means of which the compressed air lines 32 can be ventilated and vented and by means of which, if appropriate, a pneumatic pressure can be maintained in the compressed air lines 32.

The valve units 28 are also connected to the rear axle module 19 via electrical lines 36 in order to receive control signals from the latter for the purpose of activating the valve units 28. The two valve units 28 can advantageously also be integrated into the front axle module 24.

In addition, wheel speed sensing means 38, which are connected to the rear axle module 19 via electrical lines 40 are provided on the wheels 20. The wheel speed sensing means 38 serve to determine the respective wheel speed. They are each composed of a pole wheel 42, which is connected to the respective wheel 20 so as to rotate with it and is electromagnetically coupled to a wheel sensor 44, which operates actively or passively. It is possible, for example, for locking or slipping of the wheels 20 to be detected by means of the wheel speed sensing means 38, and for the brake pressure at the brake cylinders 30 to be adjusted, in particular reduced when there is a tendency of a wheel 20 to lock, by means of corresponding control signals from the rear axle module 19 to the valve units 28. In this way, an anti-lock brake function for the wheels 20 is made available.

The front axle module 24 is also connected to the brake pedal device 18 via a compressed air line 46. This compressed air line 46 conveys a pneumatically modulated pressure as a redundancy pressure from the brake pedal device 18 to the front axle module 24. For this purpose, compressed air is made available to the brake pedal device 18 from the compressed air reservoir vessel 22 via a compressed air line 46A. Finally, the front axle module 24 can have a terminal 47 for an electric power supply.

A second brake circuit has a second compressed air reservoir vessel 48, which is pneumatically connected to the rear axle module 19 via a compressed air line 50 and to the brake pedal device 18 via a compressed air line 52. A pressure, which is modulated by means of the brake pedal device 18 passes, in the event of a failure of the electronics, to the first module 19 via a compressed air line 53 as the redundancy pressure. This second brake circuit also comprises brake cylinders 54, wherein each of the brake cylinders is respectively assigned to a wheel 56 of the rear axle 14. The brake cylinders 54 are connected via compressed air lines 58 to the rear axle module 19. One or more valves for metering brake pressure for the brake cylinders 54 are provided within the rear axle module 19. The valve or valves is/are one or more solenoid valves by means of which the compressed air lines 58 can be ventilated and vented and by means of which, if appropriate, a pneumatic pressure can be maintained in the compressed air lines 58.

The rear axle module 19 has a terminal 58A for an electric power supply. The rear axle module 19 is also connected to the front axle module 24 via an electrical line 59. The rear axle module 19 transmits, via this electrical line 59, control signals to the front axle module 24 for controlling one or more valves for metering brake pressure for the brake cylinders 30. The rear axle module 19 therefore also has, as well as the control apparatus 17, control electronics or a control logic 59A for metering the brake pressure for the brakes at the front axle 12 as well as a control logic 59B for metering the brake pressure at the rear axle 14. The control logic 59A and 59B are actuated by the control apparatus by means of braking force control signals, and have power electronics components for making available electrical power for the actuation of brake components such as solenoid valves or electromechanical actuators.

Wheel speed sensing means 60, which permit the respective wheel speed to be determined, are also provided on the wheels 56 of the rear axle 14. The wheel speed sensing means 60 are in turn each composed of a pole wheel 62, which is connected to the wheel 56 so as to rotate with it and is electromagnetically coupled to a wheel sensor 64, which operates actively or passively (inductively). The wheel speed sensing means 60, in particular the wheel sensors 64, are connected to the rear axle module 19 via electrical lines 66. Locking or slipping of the wheels 56 in the rear axle 14 can be detected by means of the wheel speed sensing means 60, and the metering of brake pressure to the brake cylinders 64 can be correspondingly varied in order to counteract a tendency of the wheels 56 to lock or increase the slipping of these wheels 56.

The rear axle module 19 is also connected via an electrical line 68 to the brake pedal device 18 and receives an electrical brake request signal from a brake value signal generator 69 of the brake pedal device 18 via this electrical line 68. While taking into account the electrical brake request signal, the rear axle module 19 measures, just as the front axle module 24, the brake pressure to be fed to the brake cylinders 54 and 30, respectively.

The rear axle module 19 is also connected by an electrical line 70 to a trailer control valve 72 of a third brake circuit. This third brake circuit has a third compressed air reservoir vessel 74 connected via a compressed air line 76 to the trailer control valve 72. The trailer control valve 72 serves to control the brake pressure of a hitchable trailer vehicle (not illustrated). The trailer control valve 72 outputs the compressed air drawn from the compressed air reservoir vessel 74 to a brake system of a hitchable trailer vehicle in accordance with electrical control signals or a pneumatic pressure, in particular the electrical control signals, which are obtained from the rear axle module 19 by means of the electrical line 70 or the pneumatic pressure, which is fed from the brake pedal device 18 via a compressed air line 77, via compressed air terminals 78, 80. The trailer control valve 72 therefore indirectly receives, via the rear axle module 19, an electrical signal, for example a pulse-width-modulated signal, which represents the braking request of the driver, and a redundant pneumatic pressure or pneumatic redundancy pressure, which is modulated directly by means of the brake pedal device 18.

In addition, an electrical plug-type terminal 82 for supplying power and transferring data to and from the trailer vehicle is provided. The electric plug-type terminal 82 is connected via an electrical line 84 to the brake pedal device 18 and can alternatively also be connected to a module 19 on the frame.

The brake pedal device 18 is also connected to a rolling brake signal generator 85 via which a rolling brake function can be activated or deactivated. This rolling brake function is, for example, configured such that after the rolling brake function is activated when the vehicle is driving, monitoring takes place to determine whether the vehicle comes to a standstill. When the stationary state of the vehicle is detected as a result of activation of the brakes by the driver, the respectively present or predetermined brake pressures in the brake cylinders 30, 54 and in the trailer brake system are then kept automatically at the currently present level or at a predetermined level by actuation of the valve units 28 and of the valves, which are provided in the rear axle module 19, without the driver having to continue to activate the brake pedal. As a result, the vehicle can also be held in the stationary state on an inclined roadway even after the brake pedal has been released. As soon as it is detected that the driver is attempting to drive off with the vehicle, the wheel brakes and the trailer brake system are automatically released.

The wheel speed sensing means 38, 60 can, moreover, be used to detect whether the vehicle starts to roll when the rolling brake is activated and the stationary state of the vehicle is first reached. If this is the case, the braking force is increased by the brake cylinders 30, 54 and/or, if appropriate, electromechanical actuator elements, which are present making available larger brake application forces for the wheel brakes.

The brake pedal device 18, the front axle module 24 and the rear axle module 19 are directly or indirectly connected to one or more electrical power supplies (not illustrated). The brake pedal device 18 is advantageously connected via a terminal 86 to a first electrical power supply of a first circuit, which also supplies the front axle module 24 and the rear axle module 19 via its terminal 58A. The brake pedal device 18 is advantageously also connected via a terminal 87 to a second electrical power supply of a second circuit, which, if appropriate, also supplies a parking brake control unit. The brake pedal device 18 is therefore advantageously connected to both circuits. The brake pedal device 18 therefore advantageously has at least a double power supply in order to ensure the functioning of the brake pedal device 18 in the case of a simple fault.

The abovementioned electrical line 68, which connects the rear axle module 19 to the brake pedal device 18, is provided as primary communication line. The brake pedal device 18 also has a terminal 88 for a data bus, in particular for a CAN bus. This data bus connects the brake pedal device 18 to the rear axle module 19 via an input (not illustrated). The data bus advantageously serves as a secondary or redundant communication line between the brake pedal device 18 and the rear axle module 19. Therefore, at least two data connections to devices of the brake system, in particular to the control apparatus 17, are advantageously provided instead of just one terminal 88, for reasons of redundancy.

Likewise, for reasons of redundancy, the brake pedal device 18 advantageously has at least two sensors for detecting the set point value of the braking request, for example of the deceleration request, which set point value is output as an electrical braking request signal.

In addition, the brake pedal device 18 has a diagnostic terminal 90, which forms an interface, in particular for connecting a maintenance computer for maintenance and fault analysis.

The brake pedal device 18 can advantageously have one of, a plurality of or all of the specified and following features: The brake pedal device 18 can have a control apparatus as well as one or more terminals for actuating brake lights of the vehicle. In addition, the brake pedal device 18 can have means, in particular sensors, or terminals for such means for reading out, if appropriate, only optionally present operator control elements of the brake system in the cabin of the vehicle, in particular in its driver's cab or cockpit. Further, the brake pedal device 18 can have connections for actuating visual and/or acoustic signals of the brake system in the cabin, in particular in the driver's cab or cockpit, or outside the vehicle.

In addition, the brake pedal device 18 advantageously has at least one terminal for an electrical connection for controlling the drive unit of the vehicle for initiating an assisting engine brake. That is, a signal that initiates or controls an assisting engine brake can be generated by means of the brake pedal device 18.

The brake pedal device 18 also advantageously has a terminal for an electrical connection to a retarder for generating a braking effect by means of the retarder. That is, the brake pedal device 18 can generate an electrical signal for controlling the retarder brake.

In addition, the brake pedal device 18 advantageously has at least one terminal for an electrical connection to electric motor components in the drive line of the vehicle such as, for example, to a starter-generator unit, a hybrid unit or the like, by means of which a further assisting braking effect can be achieved. That is, the brake pedal device 18 generates at least one electrical signal for actuating such electric motor components in order to generate further braking effects.

In one embodiment (not illustrated), the control electronics or control logic for controlling the brakes on the front axle 12 and/or for controlling the brakes on the rear axle 14 are integrated into the brake pedal device 18, with the result that the corresponding electronics or logic in a module are eliminated. The electropneumatic valves of the front axle module 24 or of the rear axle module 19 can be actuated by the brake pedal device 18 in this case.

Overall, the brake pedal device 18 therefore forms an interface between the driver, the brake system 16 and the rest of the vehicle.

FIG. 2 is a schematic view of a three-axle vehicle 92, also with a front axle 12 and a rear axle 14 as well as a first additional axle 94 as a second rear axle and a brake system 96 with three brake circuits of a service brake, which can be activated by means of the brake pedal device 18. The second exemplary embodiment is similar in significant parts to the first exemplary embodiment. In particular, identical reference numbers denote identical parts.

A first module 98 is similar in its functionality, with respect to the brakes of the front axle 12 and of the rear axle 14, to the rear axle module 19 of the first exemplary embodiment according to FIG. 1. However, a control apparatus 99 in the first module 98 additionally generates a braking force control signal for brakes of the first additional axle 94 and controls, by means of a control logic 99A as a function of the braking force control signal via an electrical line 100, one or more valves in a second module 102 for the purpose of actuating compressed air. The second module 102 is also connected via a compressed air line 104 to the compressed air reservoir vessel 48 and via a compressed air line 106 to the compressed air line 53 and via the latter to the brake pedal device 18. Compressed air, which is made available and modulated by means of the compressed air line 104, is made available to brake cylinders 108 via compressed air lines 110. A pneumatic redundancy is ensured in the case of a failure of the electrical systems by means of the compressed air line 106.

In addition, wheel speed sensing means 114, which are connected to the first module 98 via electrical lines 116, are provided on wheels 112 of the first additional axle 94. In order to determine the wheel rotation speeds of the wheels 112, each wheel 112 also has a pole wheel 118, which is connected so as to rotate with it and which is electromagnetically coupled to a wheel sensor 120 that operates actively or passively. The first module 98 can detect locking or increased slipping of the wheels 112 by means of the wheel speed sensing means 114, can transmit control signals to the second module 102 in response, and can reduce the pressure in the compressed air lines 110 via the valve or valves in the second module 102, and can therefore reduce the braking forces at the wheels 112. In this way, an anti-lock brake function for the wheels 112 is made available.

FIG. 3 is a schematic view of the three-axle vehicle 92 depicted in FIG. 2 with a brake system 124 according to a third exemplary embodiment. The brake system 124 is essentially the same as the brake system 96 of the second exemplary embodiment. In particular, identical reference numbers denote identical parts again. However, the brake system 124 now has a control apparatus 125, which is integrated into a first module 126, which is embodied as a rear axle module, and into a further first module 128, which is embodied as a first additional axle module. The rear axle module 126 is similar here to the rear axle module 19 of the first exemplary embodiment. However, it additionally has a terminal for a data connection 130, which permits the data to be exchanged with the additional axle module 128. In particular, a braking request signal is passed onto the additional axle module 128 via this data line 130. However, further information relating to the braking process, for example for a braking intervention of a vehicle movement dynamics controller, can also be exchanged via this data line 130. The brakes on the additional axle 94 are controlled by the additional axle module 128 in a way that is analogous to the brakes of the rear axle 14 being controlled by the rear axle module 126. In particular, the calculation of brake pressures and the control of an intervention of the anti-lock brake system take place, in contrast to the second exemplary embodiment, on the additional axle module 128. For this reason, the electrical lines 116 now connect the wheel sensors 120 to the additional axle module 128. The rear axle module 126 differs essentially from the additional axle module 128 in that, in order to control brakes of an axle 14 or 94, it additionally controls the valve or valves in the front axle module 24 and actuates the trailer control valve 72. The control logic 99A for the additional axle 94 is arranged in the additional axle module 128.

FIG. 4 is a schematic view of a four-axle vehicle 132 with the front axle 12, the rear axle 14, the first additional axle 94 and a second additional axle 134, which is a third rear axle, as well as a brake system 136. This brake system 136 is essentially similar, with respect to the service brake function for the wheels 20, 56 and 112 on the axles 12, 14 and 94, to the brake system 124 of the third exemplary embodiment according to FIG. 3. However, instead of the first additional axle module 128, a first module 138 is now installed as a first additional axle module or second rear axle module 144, which additionally controls the brakes on wheels 140 of the second additional axle 134. A control apparatus 141 is integrated into the two first modules 126 and 138. The control of brakes by the first additional axle module 138 is carried out in a way that is analogous to the control of the brakes on the front axle 12 by the rear axle module 126. The rear axle module 126 differs, in particular, from the first additional axle module 138 in that it is additionally designed to actuate the trailer control valve 72. The first additional axle module 138 has the control logic 99A for the brakes of the first additional axle 94 and a control logic 141A for the brakes of the second additional axle 134.

The first additional axle module 138 actuates, via an electrical line 142, a second module 144 as a second additional axle module or third rear axle module. In particular, it controls one or more valves in the second additional axle module 144. Further terminals connect the second additional axle module 144 to the compressed air reservoir vessel 48 via a compressed air line 146 and via a compressed air line 148 to the brake pedal device 18, indirectly via the compressed air lines 106 and 53. Pressure in compressed air lines 150 and 152 at brake cylinders 154 can therefore be modulated both electropneumatically by means of the valve or valves in the second additional axle module 144 or pneumatically by means of the brake pedal device 18 via the compressed air lines 53, 106 and 148.

In turn, wheel speed sensing means 158 are provided on the wheels 140 of the second additional axle 134 and are connected to the first additional axle module 138 via electrical lines 160. The wheel speed sensing means 158 each have a pole wheel 162, which is connected to the respective wheel 140 so as to rotate with it and which is electromagnetically coupled to a wheel sensor 164, which operates actively or passively. Locking or increased slipping of the wheels 140 can therefore be detected by the first additional axle module 138. In response to detected locking or increased slipping of the wheels 140, valve units 166 can be actuated via electrical lines 150 and 168, by means of which the compressed air lines 132 can be at least partially vented and therefore the braking forces of the wheels 140 can be reduced.

The second additional axle module 144 can also have a terminal 169 for electrical power supply.

FIG. 5 is a schematic view of the two-axle vehicle 10 from FIG. 1 with the front axle 12 and the rear axle 14 as well as a brake system 170, which is essentially similar to the brake system 16 of the first exemplary embodiment. In turn, identical reference numbers denote identical parts.

However, in contrast to the first exemplary embodiment according to FIG. 1, a data line 172 is provided between a first module 174 and a second module 176 instead of the electrical line 59 between the first module 19 and the second module 24. In comparison to the first exemplary embodiment, additional intelligence, specifically the control logic 59A, is exported from the first module 174 to the second module 176. The valve or valves in the second module 176 is/are now not directly actuated from the second module 176. The second module 176 in fact now receives data via the data line 172 on the basis of which it independently controls the valve or valves in the second module 176. The calculation of the brake pressures and the generation of the braking force signal continue to take place in the first module 174 by means of the control apparatus 17, which is arranged there. For the supply with electrical power, the second module 176 has a terminal 47 for a connection to an electrical power supply.

FIG. 6 is a schematic view of the two-axle vehicle 10 with the front axle 12 and the rear axle 14 of the fifth exemplary embodiment according to FIG. 5 and of a brake system 178 that differs only slightly from the brake system 170 according to FIG. 5. Identical reference numbers denote identical parts again.

The first module 180 is, in contrast to the first module 174 from FIG. 5, not connected to the wheel speed sensing means 38. The electrical lines 40 now connect the wheel speed sensing means 38 to the second module 182, which has suitable terminals for this. Data relating to the sensed wheel speeds are transferred via the data line 172 to the first module 180, which controls the valve units 28 via the electrical lines 36.

FIG. 7 is a schematic view of the two-axle vehicle 10 with the front axle 12 and the rear axle 14 of the sixth exemplary embodiment, and of a brake system 184 that differs essentially from the brake system 178 of the sixth exemplary embodiment through the actuation of the valve units 28. The brake system 184 has a first module 186 and a second module 188. The second module 188 is connected to the valve units 28 via the electrical lines 36 and controls these valve units 28. The brake system 184 is otherwise similar to the brake system 176 in FIG. 6. Identical reference numbers denote identical parts here.

FIG. 8 is a schematic view of the three-axle vehicle 92 of the second exemplary embodiment depicted in FIG. 2 with the front axle 12, the rear axle 14 and the additional axle 94 as a second rear axle as well as a brake system 190. Identical reference numbers denote identical parts. Presented in simplified terms, the brakes of the additional axle 94 are controlled in a way that is analogous to the brakes of the front axle 12. For this purpose, a second module 188′ or additional axle module is provided, which is embodied like the front axle module or second module 188. A rear axle module or first module 192 consequently calculates braking forces for brakes on all three axles 12, 14 and 94 and performs open-loop or closed-loop control of corresponding braking forces by means of associated braking force control signals. The second axle module 188′ is connected via a data line 193 to the first module 192. The second module 188′ receives data via this data line 193, by means of which data it actuates one or more valves in the second module 188′. A modulated pressure passes via the compressed air lines 110 and compressed air lines 194 to the brake cylinders 108. The second module 188 can detect locking or increased slipping of the wheels 112, and in response to this can actuate valve units 198 between the compressed air lines 110 and 194 via electrical lines 196 in order to at least partially vent the compressed air lines 194. For the supply with electrical power, the second module 188′ has a terminal 122 for a connection to an electric power supply.

FIG. 9 shows a schematic view of the two-axle vehicle 10 with the front axle 12 and the rear axle 14 as well as a brake system 200 according to a ninth exemplary embodiment. This exemplary embodiment differs essentially from the first exemplary embodiment according to FIG. 1 in that, instead of the second module 24 and the valve units 28, two second modules 202 are provided as wheel modules on the wheels 20 of the front axle 12. Identical reference numbers denote identical parts.

A first module 204 is similar in its function to the first module 19 in FIG. 1. However, the need to provide, in addition to the electrical lines 36, further electrical lines for transmitting signals to the second modules 202, is eliminated. Electrical signals, which were transported via the electrical lines 36 and 59 in the first exemplary embodiment, can now pass together via the electrical lines 36 to the second modules 202. These second modules 202 are connected to the compressed air reservoir vessel 22 via compressed air lines 206 and the compressed air line 26. A pneumatically modulated redundancy pressure is fed to the second modules 202 via the compressed air line 46 and compressed air lines 208. A valve or valves in the second modules 202 is/are controlled by the first module 204 directly via the electrical lines 36. However, the second modules 202 do not have their own intelligence, i.e., they do not have a separate control logic.

FIG. 10 is a schematic view of the two-axle vehicle 10 from FIG. 9 with the front axle 12 and the rear axle 14 as well as a brake system 210 according to a tenth exemplary embodiment. Identical reference numbers denote identical parts. This tenth exemplary embodiment behaves approximately with respect to the ninth exemplary embodiment according to FIG. 9 in the same way as the fifth exemplary embodiment according to FIG. 5 with respect to the first exemplary embodiment according to FIG. 1. In comparison to the second modules 209 of the ninth exemplary embodiment, wheel modules or second modules 212 have additional intelligence such that they can automatically actuate one or more included valves. Information for this actuation is obtained by the second modules via data lines 172′ from a first module 214, which is similar in its functionality to the first module 174 of the fifth exemplary embodiment according to FIG. 5. The second modules 202 also each have a terminal 47′ for the supply of electrical power.

FIG. 11 is a schematic view of the two-axle vehicle 10 with the front axle 12 and the rear axle 14 as well as a brake system 216 according to an eleventh exemplary embodiment. This exemplary embodiment is essentially similar to the tenth exemplary embodiment according to FIG. 10 and behaves with respect to that exemplary embodiment in the same way as the seventh exemplary embodiment according to FIG. 7 behaves with respect to the fifth exemplary embodiment according to FIG. 5. Here, identical reference numbers denote identical parts again. The brake system 216 has a first module 218 as a rear axle module and two second modules 220 as wheel modules on the wheels 20 of the front axle 12. These second modules 220 have an intelligence by means of which locking or increased slipping of the wheels 20 can be detected, and in response thereto the compressed air lines 34 can be at least partially vented. For this purpose, the wheel speed sensing means 38 are connected directly to the second modules 220 via the electrical lines 40. The control apparatus 17 is arranged in the first module 218. The second modules 220 each have a control logic for actuating one or more valves in the second modules 220.

FIG. 12 shows the vehicle 10, which is embodied as a truck, having a brake system 221 according to the first exemplary embodiment of the invention, in a simplified, schematic side view. The vehicle 10 has a supporting structure 222 and a cabin 224. The cabin 224 is embodied as a front-steered driver's cab with mechanical or hydraulic driver's cab tilting device and is supported by the supporting structure 222. This supporting structure 222 is embodied as a conductor frame and it can support and transport loads, for example containers, as well as the driver's cab or the cabin 224. The supporting structure 222 and the conductor frame are supported by the wheels 20 of the front axle 12 and the wheels 56 of the rear axle 14.

The cabin 224 has a driver's seat 226 and the brake pedal device 18 with the braking value signal generator 69. An interface 228 is integrated into the brake pedal device 18. A braking request signal, which is generated by means of the braking value signal generator 69, is conducted to the interface 228 and from there from the brake pedal device 18, in the cabin 224 via a data bus connection 230 to the control apparatus 17, which is integrated into a rear axle module 232. The control apparatus 17 forms open-loop or closed-loop control of corresponding braking forces in response to the braking request signal, both for brakes on the wheels 20 of the front axle 12 and for brakes on the wheels 56 of the rear axle 14 by means of the associated braking force control signals.

Further data are exchanged between devices in the cabin and devices on the supporting structure via the interface 228 and the data bus connection 230. For example, a driver in the cabin can generate a signal for applying a parking brake by means of an input device. This signal is transmitted to the interface 228, which transfers corresponding data to the control apparatus 17 via the data bus connection 230. For this reason, the rear axle module 232 advantageously also has a parking brake modulator in addition to the control apparatus 17 for the service brake. However, alternatively, a parking brake modulator can also form a separate unit. Data for controlling a parking brake function are then passed onto this separate unit either from the rear axle module 232 or the control apparatus 17, or else are already previously branched off via a branch or a distributor in the data bus connection 230.

Furthermore, lights that are also arranged on the supporting structure can, for example, be actuated via the interface 228 and the data bus connection 230. These lights may be brake lights, a headlight or even flashing indicator lights. Any communication between devices in or on the cabin 224 and devices on the supporting structure 222 can therefore be conducted via the data bus connection 230.

FIG. 13 shows a brake system 236 in a vehicle 238, which is embodied as a bus, in a simplified side view. The axles 12 and 14 with the wheels 20 and 56 support, in this case, a self-supporting vehicle bodywork that forms a supporting structure 240. The vehicle 238 has a cabin 242, which is supported by the supporting structure 240 of the vehicle bodywork and is enclosed by this vehicle bodywork and forms a passenger compartment in the vehicle bodywork. The cabin 242 has the driver's seat 226 and numerous further seating places for passengers. A braking request signal, which is generated by means of the braking value signal generator 69 of the brake pedal device 18, is fed to control apparatuses 244 via the electrical line 68. The control apparatuses 244 are integrated into four wheel modules 246. The wheel modules 246 are embodied in the same way and can, in principle, be exchanged one for the other. The four wheel modules 246 are connected to one another via data lines 130 and exchange, via these data lines 130, data for the purpose of controlling brakes on the wheels 20 and 56. The wheel modules 246 are arranged in the region of the wheels 20 and 56 on wheel cases on the supporting structure 240, from where they are easily accessible from the outside for possible maintenance and/or repair work.

Each wheel module 246 is therefore assigned to a wheel 20 or 56, has one or more valves and controls, by means of this valve or these valves, a brake pressure for activating a brake of the respective wheel 20 or 56. The control apparatus 244 of each wheel module 246 is, on the other hand, of quadruple design. It is therefore possible for each wheel module 246 to calculate a braking force control signal for a brake on each of the wheels 20 and 56. By comparing the four braking force control signals, it is possible to detect possible malfunctions in the control apparatus automatically and effects of a faulty control apparatus on the braking behavior can be avoided. The valve or valves on a wheel module 246 are in fact controlled by control logic 248 to which braking force control signals are fed from a control apparatus 244, which is detected as functionally capable. Alternatively, the control logic can also be of quadruple redundant design in order to be able to directly actuate valves in four wheel modules 246, if appropriate.

In an embodiment (not illustrated) of the invention, which differs from the above, the control apparatus is of double design and is distributed between two axle modules, which each replace two wheel modules 246. These two axle modules cannot detect any malfunctions of the respective other axle module. However, in the event of failure of a control apparatus they can assume the functions of the failed control apparatus. The control apparatus or axle modules are also in this case preferably arranged on, in each case, one wheel case on the axles 12 and 14.

In a further alternative embodiment (not illustrated), the brakes on the wheels 20 and/or 56 can be additionally or alternatively actuated electromechanically. If appropriate, it is therefore possible to dispense with valves in wheel modules. Pneumatic redundancy may be present, but can also be dispensed with if appropriate. Numerous components of the brake system can be of multiple design in order to reduce the risk of the entire brake system failing. In particular, all the electrical components can have two terminals for two power supplies, in particular two batteries. Two braking request signals can be generated by means of two sensors on the braking value signal generator 228. These braking request signals can be conducted to the control apparatus via two separate lines. In the event of failure of a battery or of a power supply source, of a sensor in the braking value signal generator 69, of an electric line 68 or data bus connection 230 or in the case of the redundant design of the control apparatus, it is therefore also always possible for a vehicle to be safely braked and therefore safely operated even in the event of a failure of the control apparatus.

The exemplary embodiments according to FIGS. 1 to 11 show particularly preferred embodiments of the invention. However, they do not constitute a restriction. In particular, the invention can be extended to vehicles with any desired number of axles. Every first or second module can perform control functions for one or more brakes on one or more wheels and/or axles. The control apparatus can be distributed among as many modules on the supporting structure of the vehicle as desired. The control apparatus is always arranged outside a cabin of the vehicle here.

However, other parts of the brake system, which are, in particular, connected downstream of the control apparatus, can also be arranged in the cabin. In particular it is, for example, possible for the second module 188 in the seventh exemplary embodiment according to FIG. 7, and therefore the control logic 59A, to be integrated into the brake pedal device 18. The control apparatus therefore continues to be arranged in the first module on the supporting system, while the actuation of one or more valves is carried out by means of the control logic 59A, and the modulation of a pneumatic pressure is carried out by means of these valves in the brake pedal device 18.

Even if it is not explicitly illustrated in the appended drawings, a brake system according to the inventive embodiments advantageously can have a parking brake device with spring-loaded brake cylinders, in particular combined spring-loaded/diaphragm brake cylinders, wherein the parking brake function can be made available by means of the spring-loaded parts of these brake cylinders. In this case, the parking brake device is embodied as an electropneumatic parking brake. Additionally or alternatively, the parking brake is embodied as an electromechanical parking brake, with the result that the parking brake function can be made available by means of electromechanical brake components. The parking brake function can alternatively be conventionally embodied with purely pneumatically operated components, without electrical control.

In the above exemplary embodiments according to FIGS. 1 to 13, the control device is integrated into a control apparatus 17, 99, 125, 141, 244 and is preferably integrated there into a rear axle modulator. However, the invention also comprises embodiments in which the control device is not integrated into another apparatus but is instead attached as a stand-alone structural unit to the frame of the vehicle.

All the features specified in the description above and in the claims can also be combined individually with the brake system according to the inventive embodiments. The invention is therefore not restricted to the described or claimed feature combinations. As said, all the combinations of individual features should be considered to be disclosed.

1. A control device for controlling a brake system of a vehicle (10; 92; 132; 238), wherein the vehicle (10; 92; 132; 238) has a supporting structure (222; 240) and a cabin (224; 242) which is supported by the supporting structure (222; 240) and has at least one driver's seat (226), wherein the control device (17; 99; 125; 141; 244) is arranged outside the cabin (224; 242) on the supporting structure (222; 240), wherein the control device (17; 99; 125; 141; 244) has an additional functionality for controlling an electronic air spring system.

2. The control device as claimed in claim 1, characterized in that the control device has an additional functionality for controlling a tire pressure monitoring system.

3. The control device according to claim 2, characterized in that ABS lines (40; 66) which lead from the control device to wheel speed sensors (38; 60) are used as antennas for receiving signals from tire pressure monitoring modules which detect the tire pressure and are mounted on or in wheels (20; 56) or tire valves of the vehicle.

4. The control device as claimed in claim 2, characterized in that the ABS lines (40; 66) which lead from the control device to wheel speed sensors (38; 60) are used as electrical feed lines to antennas which are mounted in wheel housings of the vehicle and have the purpose of receiving signals of the tire pressure monitoring modules.

5. The control device as claimed in claim 3 or 4, characterized in that the tire pressure monitoring modules are assigned to wheel housings or wheels (20; 56) of the vehicle on the basis of the signals of the tire pressure monitoring modules which are transmitted via the ABS lines (40; 66).

6. The control device as claimed in one of the preceding claims, characterized in that the control device has an additional functionality for controlling a parking brake modulator, an anti-lock brake system, a vehicle movement dynamics control device and/or an electronically controlled air processing device.

7. The control device as claimed in one of the preceding claims, characterized in that the control device has additional functionalities for driver assistance systems.

8. The control device as claimed in claim 7, characterized in that the driver assistance system has the functions of a lane departure warning system (LDW), an adaptive cruise controller (ACC), a blind spot monitoring device (BSD) and/or an autonomous emergency brake system (AEBS).

9. The control device as claimed in one of the preceding claims, characterized in that the control device has at least one sensor for sensing a driving state of the vehicle.

10. The control device as claimed in claim 9, characterized in that the sensor is an acceleration sensor, yaw rate sensor and/or an inclination sensor.

11. The control device as claimed in one of the preceding claims, characterized in that the control device can generate, in response to a (224; 242), with a brake value signal generator (69), at least one braking force control signal for controlling, in particular for increasing, holding and reducing the braking force of at least one brake of the brake system (16; 96; 124; 136; 170; 178; 184; 190; 200; 210; 216) as a function of the braking request signal.

12. A brake device comprising a control device according to one of the preceding claims.
